(19) United States
(12) Patent Application Publication
(10) Pub. No.: US 2004/0145469 A1
(43) Pub. Date: Jul. 29, 2004

(54) Intrusion detector

(76) Inventors: Jacob Pendergrass, Bishopville, SC (US); Mykel A. Pendergrass, Bishopville, SC (US)

Correspondence Address: Jacob Pendergrass, 1530 Browntown Road, Bishopville, SC, 29010, US

(21) Appl. No.: 10/350,340

(22) Filed: Jan. 24, 2003

(51) Int. Cl. G08B 1/08

(52) U.S. Cl. 340/539.1; 340/567

(57) ABSTRACT

An intrusion detection system to surveil an enclosed space includes a controller, one or more infrared and motion detectors, and a remote sensor small enough so that it may be attached to a key chain. An RF network accomplishes communication between the detectors, controller and remote monitor. The system has five modes: configuration, disarmed, armed, alarmed, and fault. The system is self-arming and self-disarming and can accommodate multiple detectors in a RF network, enabling more complete coverage of the premises. Misuse by the user is eliminated since no input is required from the user except turning the system on and off.

### CROSS REFERENCE TO RELATED APPLICATIONS

The present application is a continuation of Provisional Application No. 60/351,199, filed Jan. 25, 2002, that application being expressly incorporated herein.

### BACKGROUND OF INVENTION

1. Technical Field

The present invention relates to an intrusion alarm and detection system which monitors a predetermined space, initiates an alarm as a result of an intrusion into the predetermined space and records the occurrence of the intrusion. The system is self-arming and self-disarming requiring no input from the user, thus eliminating a user inadvertently arming a disarmed system

2. Background Information

Burglar alarm systems that detect intrusions and produce an audible or visual alarm are well known. Many such systems incorporate methods allowing remote arming and disarming.

U.S. Pat. No. 5,808,547 issued to Carney on Sep. 15, 1998 presents an alarm system that monitors a predetermined space, initiates an alarm as a result of an intrusion into that predetermined space and records the occurrence of the intrusion. The system comprises an infrared sensor for detecting the intrusion and a memory circuit for recording the intrusion. The system includes a means by which to remotely arm, disarm and test the state of the system. A signaling protocol is disclosed which includes momentary activating a single button remote control in order to arm the system and activating the remote control momentary a second time in order to test the system. Disarming is accomplished by a momentary closure of a button switch while the responder is responding. If the user inadvertently presses the button again while putting the remote controller in his or her pocket while the responder is responding, the system would be unintentionally disarmed. Carney does not teach a system that is self-arming and self-disarming, thus eliminating any user mistakes or misuse.

Upon returning to the premises, the user has to distinguish between two pulses or beeps which may be difficult if the user is tired, emotionally distracted, or hearing impaired. The user has to further make a determination of which response was heard and what that response signifies. This could lead to misinterpretation by the user resulting in facing an intruder. An audible and visual response on the remote monitor indicating an “all clear” condition, as set forth in this invention will eliminate the possibility of misinterpretation along with its possible catastrophic consequences.

U.S. Pat. No. 5,473,305 issued to Hwang on Dec. 5, 1995 teaches an automobile alarm system which includes a remote controller wherein the system is armed and disarmed by the remote controller; requiring user input. Hwang's disclosure does not teach a system that is self-arming and self-disarming; not requiring any user input.

U.S. Pat. No. 5,469,151 issued to Patrick Lavelle on Nov. 21, 1995 presents an automobile alarm system which includes a remote controller which arms and disarms the system. Lavelle does not teach a system requiring no user input.

The current state of the art requires input and intervention by the user which could result in misuse or mistakes by the user. It is apparent that there is a need for a self-arming and self-disarming system that requires no input from the user.

### SUMMARY OF INVENTION

The present invention provides an autonomous intrusion detection and alarm system that is self-arming and self-disarming which can accommodate multiple detectors in a RF network, enabling more complete coverage of the premises. Misuse by the user is eliminated since no input is required from the user except turning the system on and off.

### BRIEF DESCRIPTION OF DRAWINGS

FIG. 1 is a schematic block diagram of the Intrusion Detection System.

FIG. 2 is a schematic block diagram of the Controller

FIG. 3 is a schematic block diagram of the Remote Monitor.

FIG. 4 is a schematic block diagram of the Infrared/Motion Detectors.

FIG. 5 is a Flow Chart detailing the operation of the Controller.

### DETAILED DESCRIPTION

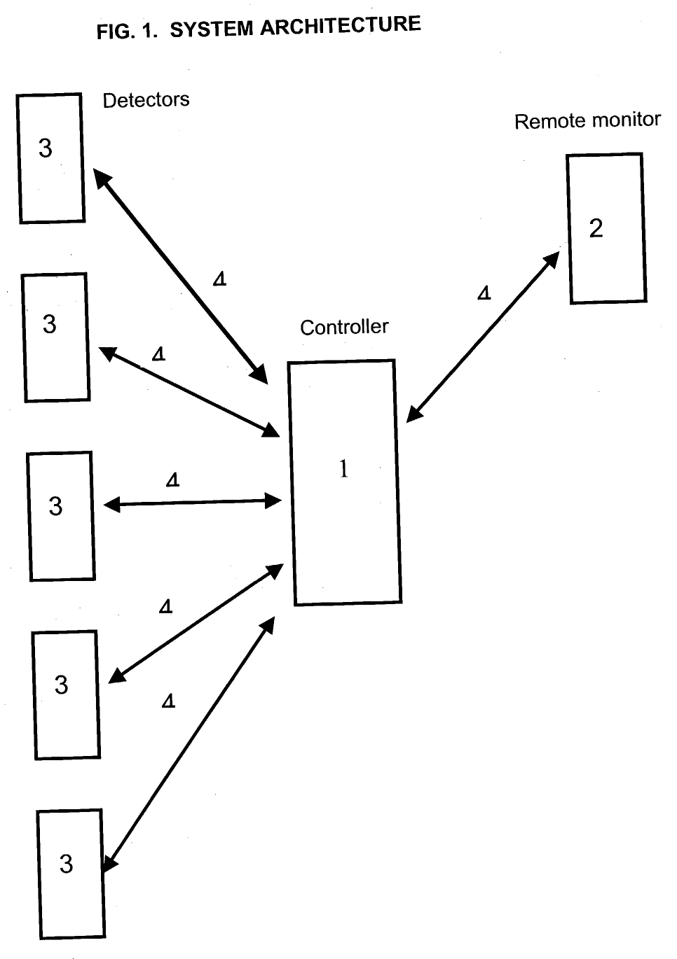

FIG. 1 shows the system architecture, consisting of a Controller (1), a Remote Monitor (2), one or more Detectors (3), and the RF Network (4) that allows communication among the devices.

When the system is first turned on, the Controller (1) will go into configuration mode. The Controller (1) will send identification requests to the Detectors (3) and each Detector (3) will respond with its identification code. Each detector (3) will listen to the RF network to determine when to respond. If two or more Detectors (3) starts responding at the same time, all will wait a random amount of time before trying respond.

The Controller (1) keeps a list of valid Detectors (3) identification codes, and test the response of the Detectors (3) against this list.

After the Detectors (3) have been verified, the Controller (1) tests for the presence of the Remote Monitor (2), by sending an identification request signal. If the Remote Monitor (2) responds with a valid identification code, the Controller (1) will complete Configuration mode and goes to Disarm mode.

While in Disarm mode, the Controller (1) periodically sends an identification request to the Remote Monitor (2), to determine if the Remote Monitor (2) is present. As long as the Remote Monitor (2) keeps responding to identification requests from the Controller (1), the Controller (1) will stay in the Disarm mode.

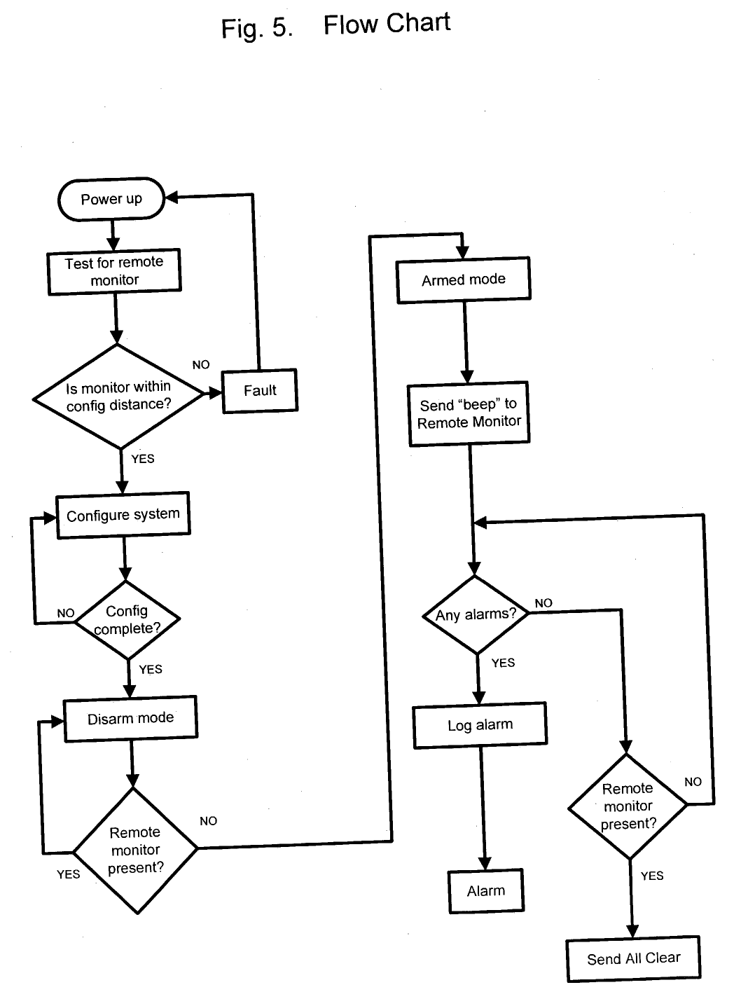

When the Remote Monitor (2) is taken out of range such that the Controller (10 can no longer receive the response from the Remote Monitor (2), the Controller (1) will go into the Armed mode. The Controller (1) will send one or more “beep” signals to the Remote Monitor (2) indicating this it is in the Armed mode. The Controller (1) will have a have a greater transmitting range than the remote Monitor (2), allowing the Remote Monitor (2) to receive the signal from the Controller (1), even though the Controller (1) can no longer receive signals from the Remote Monitor (2). When the Remote Monitor (2) is brought back into range such that the Controller (1) can receive a response to the identification request signal, the Controller (1) will send an “all clear” signal to the Remote Monitor (2) if no intrusion has occurred. The “all clear” signal will cause the Remote Monitor (2) to emit one or more audible tones or beeps and activate a LED or other visual indicator. If an intrusion has occurred, no signal is sent to the Remote Monitor (2), and the absence of a signal will alert the user that that an intrusion has occurred. FIG. 5 Shows a flow chart detailing the operation of the system.

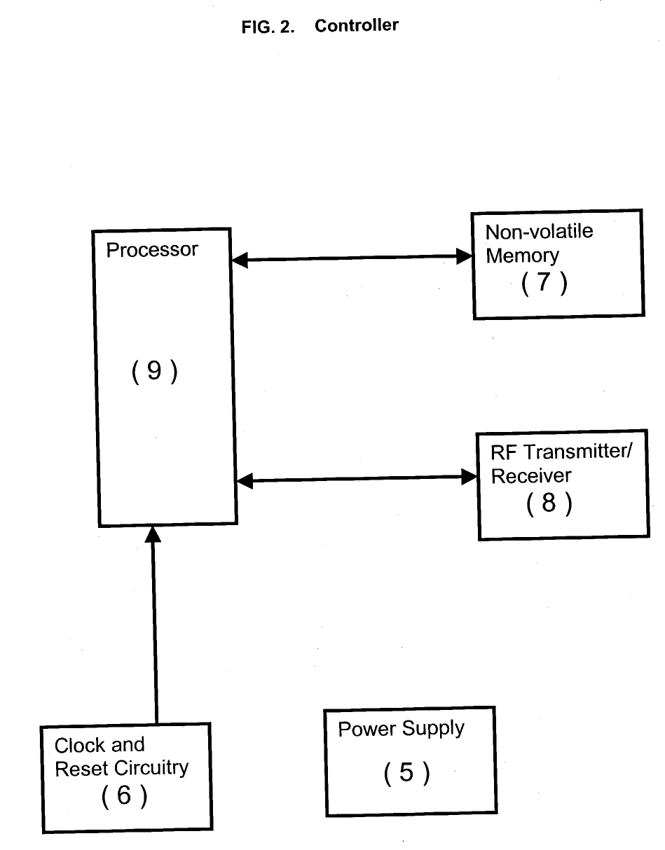

FIG. 2 shows a schematic block diagram of the Controller (1), containing a Processor (9), non-volatile memory (7), RF Transmitter/Receiver (8), clock and reset circuitry (6), and a power supply (S).

The Processor (5) is a low powered type with onboard Program Memory, and a sleep mode to conserve power. The power supply (5) can be a battery or A/C adapter. The Processor (9) will control the RF Transmitter/Receiver (8) to send identification requests to the Detector (3) and the Remote Monitor (2), and will interpret responses from same.

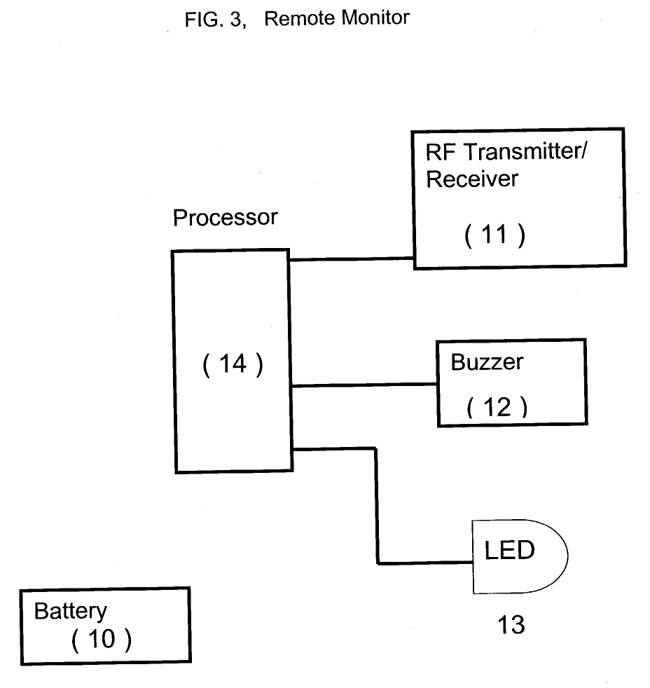

FIG. 3 is a schematic block diagram of the Remote Monitor (2), that includes a Processor (14), a RF transmitter/receiver (11) a buzzer (12), a LED (13) and a battery (10) for power.

The Processor (14) is a low powered type with onboard Program Memory and a sleep mode to conserve power. The Processor (14) controls the RF Transmitter/Receiver (11), buzzer (12) and LED (13).

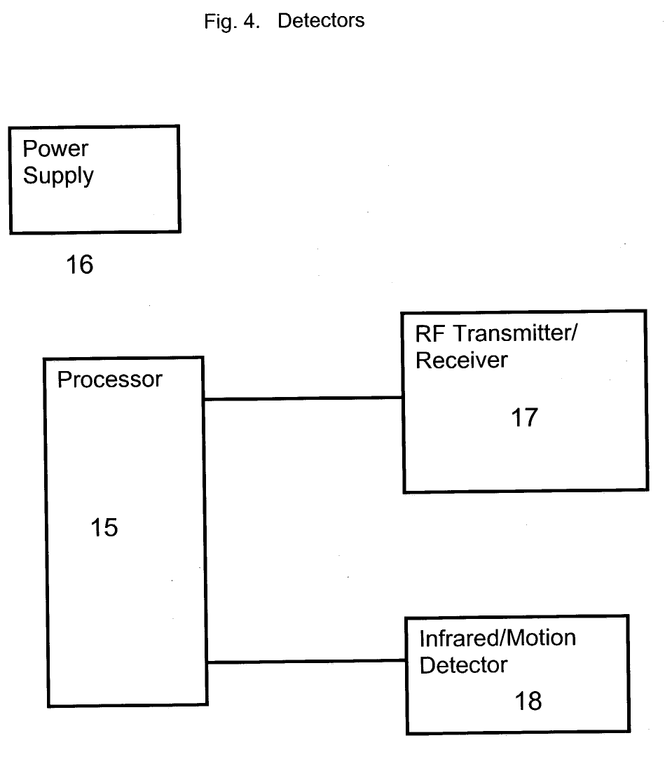

FIG. 4 shows a schematic block diagram of the Detectors (3), consisting of a power supply (16), a Processor (15), a RF Transmitter/Receiver (17), and an Infrared/motion Detector (18). The Power Supply (16) can be a battery or an A/C adapter. The Processor (15) is a low power type with onboard Program Memory and a sleep mode to conserve power. The Processor (15) receives identification requests and sends identification code and alarms through the RF Transmitter/Receiver (17).

The present invention should not be considered as being limited to the precise details of structure shown and set forth in this specification. Improvements, changes and modifications within the skill of the art are intended to be covered by the appended claims.

1. An intrusion detection system to surveil an enclosed space includes a controller, one or more infrared and motion detectors, and a remote monitor small enough so that it may be attached to a key chain.

2. A RF network accomplishes communication between the detectors, controller and remote monitor.

3. The remote monitor will have a lower transmitting power level and shorter transmitting range than the controller.

4. The controller will periodically transmit a RF signal identification request to the remote monitor to determine the remote monitor presence.

5. The system has five modes; configuration, disarmed, armed, alarm, and fault.

6. Upon power up the controller will test for the presence of the remote monitor by sending a RF signal requesting remote monitor identification and allowing a predetermine time for the remote monitor to respond.

7. If the remote monitor responds with the correct identification code, the controller will authenticate the response and enter the configuration mode.

8. If the remote monitor does not respond or responds with an incorrect identification code, the system will not configure, but will go into the fault mode.

9. After configuration, the system will enter the disarmed mode.

10. When the remote monitor is moved away from the controller to a distance outside of the transmitting range of the remote monitor, as in the case when the user leaves his or her apartment, house, or hotel room, the system will go into the armed mode.

11. When the controller goes into the armed mode a RF signal will be sent by the controller to the remote monitor causing audible tones or beeps, and momentarily energizing an LED or other visual indicator on the remote monitor.

12. If an intruder enters the protected space, one or more of the detectors will go into the alarmed mode, sending a RF signal to the controller. The controller will log the alarm and also go into the alarmed mode.

13. The user upon returning to the premises, prior to opening the door, will receive an “all clear” signal if no intrusion has occurred.

14. The absence of a signal; as in the case of an intrusion, or the intruder turns the signal off or tries to reset the system, will alert the user that an intrusion has occurred.

15. This intrusion detection system requires no input from the user other than turning the system on and off.
